(19) United States
(12) Patent Application Publication
(10) Pub. No.: US 2007/0236019 A1
(43) Pub. Date: Oct. 11, 2007

(54) Self-support power generating system

(76) Inventor: Chih-Chuan Chen, Wurih Township (TW)

Correspondence Address: SCHMEISER, OLSEN & WATTS, 22 CENTURY HILL DRIVE, SUITE 302, LATHAM, NY, 12110, US

(21) Appl. No.: 11/400,869

(22) Filed: Apr. 10, 2006

(51) Int. Cl. H02K 7/18; F03G 7/08; F02B 63/04

(52) U.S. Cl. 290/1 R

(57) ABSTRACT

A self-support power generating system, wherein an input terminal of a battery is connected to a power generator, and an output terminal of the battery is connected to a power converter. The power converter is to convert the direct current motor supplied by the battery into alternating current power, and respectively in connection with a power outlet and a motor, the motor is again connected to the power generator to form a loop circuit. With the series of the power generator charging the battery, the battery supplying power to the motor, and the motor driving the power generator, the self-support power-generating system is capable of achieving the purposes of feeding back electric power, and reducing environmental pollution and noise.

### BACKGROUND OF THE INVENTION

1. Field of the Invention

The present invention relates to a self-support power generating system, particularly a self-support power generating system that is capable of achieving self-support power, reduced environmental pollution and noise pollution.

2. Prior Art

There are a variety of power-generating systems on current market. The most typical type of them uses gasoline or diesel as fuel and the Faraday's law of electromagnetic induction to start power-generating coils. Hence, chemical energy is converted to dynamic energy, then to electric energy so as to produce required electric power. As shown in FIG. 1, that is a block diagram of a power generating system in prior arts. As shown in the figure, the power generating system 1 adopts gasoline or diesel to supplies power and a power outlet 13 providing power output. Yet producing gasoline or diesel is a high pollution industrial process so as to result in substantial contamination to our environment. Moreover, air pollution and noise generated by an engine 12 may further affect the stage of the contamination of the environment. Besides, energy lost is huge while the energy is in conversion so as to cause the low efficiency of power generation and increase costs.

In view of the shortcomings of the power generating system in the arts, the present inventor has utilized his experience for many years in the art, and has come up with a self-support type power generating system, using a simple design to achieve the purposes of feeding back electric power, reducing environmental pollution and noise pollution.

### SUMMARY OF THE INVENTION

The primary objective of the present invention is to provide a self-support power generating system to feed back electric power.

Another objective of the present invention is to provide a self-support power generating system to achieve the purposes of lowering environmental pollution and noise.

To achieve the objectives, the technical approach of the present invention is described as follows:

A self-support power generating system, wherein an input terminal of a battery is connected to a power generator, and an output terminal of the battery is connected to a power converter. The power converter is to convert direct current motor supplied by the battery into alternating current, and respectively in connection with a power outlet and a motor, the motor is again connected to the power generator to form a loop circuit. With the series of the power generator charging the battery, the battery supplying power to the motor, and the motor driving the power generator, the self-support power-generating system is capable of achieving the objectives of feeding back electric power, and reducing environmental pollution and noise.

For better understanding of the objectives, characteristics and performance of the present invention, please refer to detailed description of the preferred embodiment of the present invention with accompanying drawings.

### BRIEF DESCRIPTION OF THE DRAWINGS

FIG. 1 is a block diagram of a power generating system in prior arts;

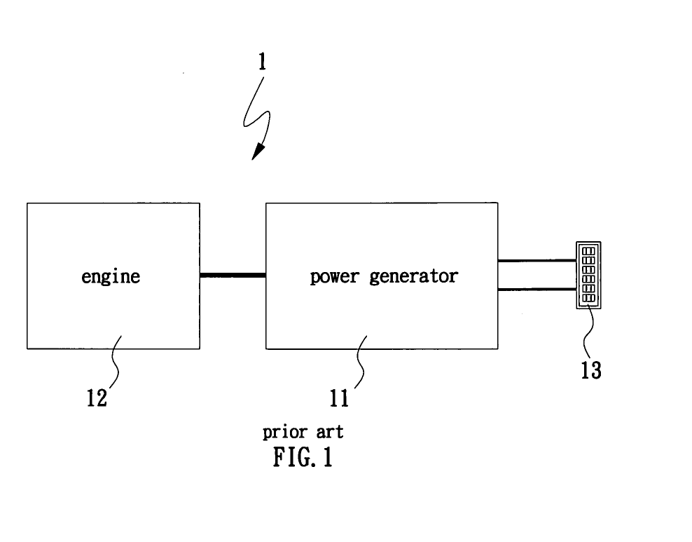

FIG. 2 is a block diagram of a first preferred embodiment of a system of the present invention;

FIG. 3 is a block diagram of a second preferred embodiment of the system of the present invention.

### DETAILED DESCRIPTION OF THE PREFERRED EMBODIMENT

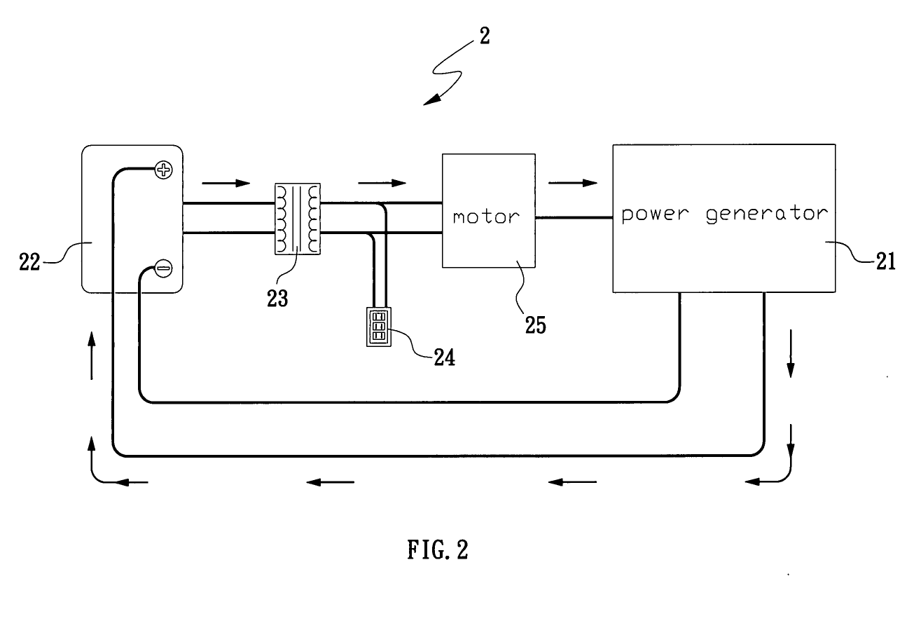

Please refer to FIG. 2, that shows a block diagram of a first preferred embodiment of a system of the present invention. As shown, the present invention of self-support power generating system 2 mainly comprises an input terminal of a battery 22 in connection with a power generator 21, the power generated by the power generator 21 being charged the battery 22. Meanwhile, an output terminal of the battery 22 is connected to a power converter 23; by such connection the power converter 23 converts direct current (generally 12 volt or 24 volts) supplied by the battery 22 to alternating current (generally 110 volts or 220 volts), and respectively connected to a power outlet 24 and a motor 25. The power outlet 24 supplies power to outside electrical appliances (such as, an electric lamp, audio equipment, a game console, etc.), while the motor 25 is in connection with the power generator 21 to form a loop circuit for starting the power generator 21 by means of a belt, gears or a shaft for transmission. Thereby, the power generator 21 charges the battery 22. The battery 22 provides power through the power converter 23 to the motor 25. The motor 25 again drives the power generator 21 to charge the battery 22, and a circle of self-support power is formed. Since the power generated by the power generator 21 can be fed back to the system, and the power generated is electric power. The system is free from environmental pollution, since there is no gasoline or diesel to be as fuel. Without the use of gasoline or diesel, no engine will be required in this system; thereby there will be no such problems as environmental pollution or noise.

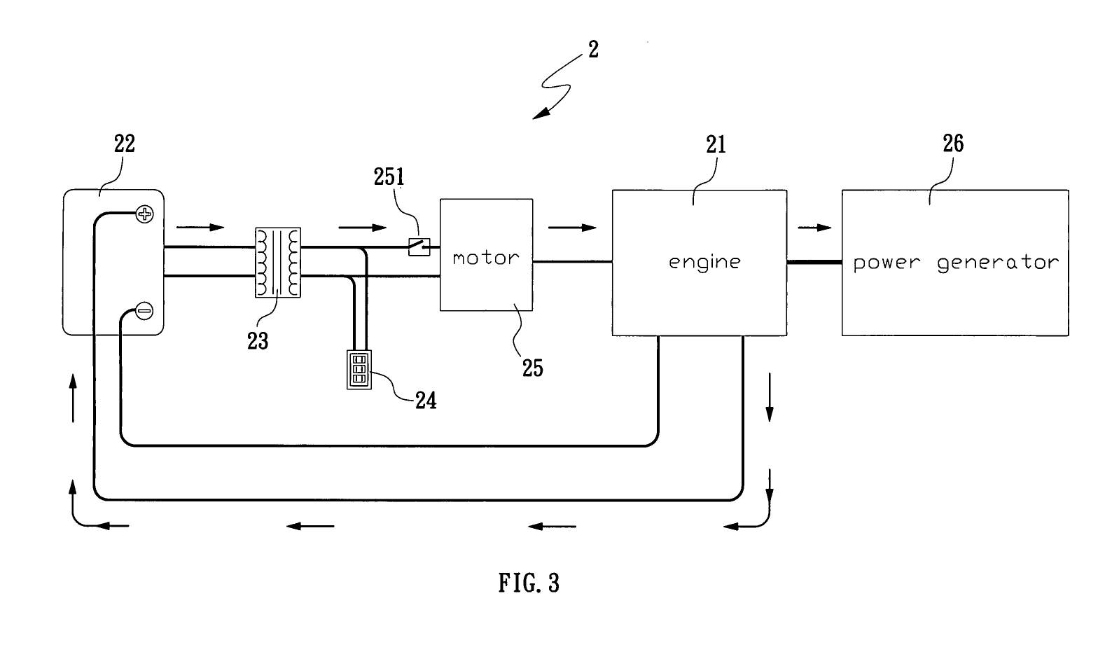

Please refer to FIG. 3, that shows a block diagram of a second preferred embodiment of the system of the present invention. As shown, the self-support power generating system 2 is applied on a car, but without a motor 25. An engine 26 available on the car is to start the power generator 21 for replacing the motor 25. Optionally, a control switch 251 is installed between the motor 25 and a power converter 23. By switching on or off the motor 25, the preferred embodiment can be used in all regular occasions or on automobiles.

Summing up, the present invention of self-support power generating system is applicable, with improvement on the shortcomings of the prior art, innovative, satisfactory to industrial requirement, having the characteristics of novelty and an inventive step, and satisfied the statutory requirements for a patent, therefore this application is duly filed.

What is claimed is:

1. A self-support power generating system, comprising at least:
a power generator;
a battery, an input terminal thereof being connected to the power generator;
a power converter being connected to an output terminal of the battery and converting direct current supplied by the battery to alternating current;
a power outlet being connected to the power converter; and
a motor, one terminal thereof being connected to the power converter, another terminal thereof being connected to the power generator.

2. The self-support power generating system of claim 1, wherein a control switch is installed between the motor and the power converter.
